(19) United States
(12) Patent Application Publication
(10) Pub. No.: US 2025/0075354 A1
(43) Pub. Date: Mar. 6, 2025

(54) BIPOLAR PLATE FOR AN ELECTROCHEMICAL SYSTEM WITH A SUPPORT ELEMENT

(71) Applicant: Reinz-Dichtungs-GmbH, Neu-Ulm (DE)

(72) Inventors: Jonas LEISCHER, Neu-Ulm (DE); Steffen ERTHLE, Dornstadt (DE); Oliver CLAUS, Laichingen (DE); Wilhelm KUHN, Merklingen (DE); Franz SCHWEIGGART, Pfaffenhofen (DE); Hans WALDVOGEL, Krumbach (DE); Christoph SPECHT, Neu-Ulm (DE)

(21) Appl. No.: 18/826,000

(22) Filed: Sep. 5, 2024

(30) Foreign Application Priority Data
Sep. 6, 2023 (DE) 20 2023 105 129.4

(51) Int. Cl. C25B 13/05; C25B 9/23; H01M 8/1004; H01M 50/431

(52) U.S. Cl. CPC C25B 13/05; C25B 9/23; H01M 8/1004; H01M 50/431

(57) ABSTRACT

A bipolar plate for an electrochemical system, such as an electrolyzer, having a separator plate and a support element firmly connected to the separator plate. The separator plate comprises a through-opening as an inlet or outlet for a fluid, a fluid guiding structure with a plurality of protrusions arranged at the through-opening for guiding the fluid between the plurality of protrusions, a bead arrangement which partially surrounds the through-opening, and a flow field with an electrochemically active region. The fluid guiding structure is arranged between the through-opening and the flow field such that the fluid can flow from the through-opening through the fluid guiding structure to the flow field or vice versa. The support element is configured to bridge the fluid guiding structure.

### CROSS REFERENCE TO RELATED APPLICATION

This application claims priority to German Utility Model Application No. 20 2023 105 129.4, entitled “BIPOLAR PLATE FOR AN ELECTROCHEMICAL SYSTEM WITH A SUPPORT ELEMENT”, filed Sep. 6, 2023. The entire contents of the above-identified application is hereby incorporated by reference for all purposes.

### TECHNICAL FIELD

The present disclosure relates to a bipolar plate for an electrochemical system, which has a separator plate and a support element. Furthermore, the present disclosure relates to an arrangement for an electrochemical system with the bipolar plate. Furthermore, the present disclosure relates to an electrochemical system comprising a plurality of stacked bipolar plates or a plurality of stacked arrangements.

### BACKGROUND AND SUMMARY

The electrochemical system can be a fuel cell system, an electrochemical compressor, a redox flow battery or an electrolyzer.

A fuel cell system generally converts chemical reaction energy into electrical energy. In known fuel cell systems, for example, hydrogen and oxygen are converted into water and electrical energy.

In contrast to the fuel cell system, a chemical reaction, i.e. a material conversion, is brought about in an electrolyzer by means of an electric current. For example, a water electrolyzer breaks down water into hydrogen and oxygen by applying an electrical voltage.

In general, electrochemical systems typically comprise a stack of individual electrochemical cells, each comprising a plurality of layers including at least a bipolar plate and a membrane electrode assembly (MEA), several MEAs each being separated from one another by bipolar plates. The stack of individual electrochemical cells can have two end plates that press the individual electrochemical cells together and provide the stack with stability. Furthermore, the individual electrochemical cells can comprise gas diffusion layers that are arranged between the bipolar plate and the membrane electrode arrangement. The bipolar plate can fulfill several functions: indirect electrical contacting of electrodes of the membrane electrode assembly (MEA), separation of media such as water, oxygen or hydrogen and electrical connection of the neighboring individual electrochemical cells.

The stack of individual electrochemical cells must be sealed off from an external space, as a fluid or medium inside the individual electrochemical cells is often under high pressure compared to the external pressure. Depending on the type of electrochemical system, the fluid can include hydrogen, air (oxygen), water, cooling medium and/or mixtures thereof, for example. For this purpose, the electrochemical system can have at least one cell frame running around the outer edge of the individual electrochemical cell for each of the individual electrochemical cells, particularly in electrolyzer applications, in order to achieve a sealing effect. In addition, the electrochemical system can comprise one or more sealing layers for each of the individual electrochemical cells in order to increase the sealing effect.

A bipolar plate comprises at least one through-opening as an inlet or outlet for a fluid, a flow field with an electrochemically active region, and an intermediate fluid guiding structure for guiding the fluid between the through-opening and the flow field. The fluid guiding structure can provide a fluidic connection between the through-opening and the flow field.

The bipolar plate often comprises a port or through-opening, an electrochemically active surface and a guiding and support element for guiding a medium between the port and the active surface. The guiding and support element is sometimes formed by several protrusions of the bipolar plate, so that there are respective passages between the adjacent protrusions. The medium flows through the passages. The bipolar plate can be single or multi-layered. While bipolar plates in fuel cells are often double-layered so that cooling fluid can flow between the two individual layers, bipolar plates in electrolyzers are usually single-layered. Each layer of a bipolar plate can be regarded as a separator plate, as this layer separates the media.

In addition to bipolar plates and membrane electrode arrangements, other layers can also be provided. Cell frames and/or cell seals can be arranged between adjacent bipolar plates to seal the cells.

However, such conventional electrochemical systems have the following problems. The layer lying on the bipolar plate (i.e. cell frame or cell seal) crosses the passages of the guide and support element and is not supported by the bipolar plate in this region. When pressing the electrochemical cell, the layer in this region cannot transfer sufficient pressure or compression. On the other hand in the case of a single-layer bipolar plate, the region of the guiding and support element must be crossed, as the anode side and the cathode side of the bipolar plate, particularly of an electrolyzer, are made from a single sheet, i.e. they lie congruently on top of each other during stacking or assembly and can only transmit the force required for sealing via the strength and/or rigidity of the cell frame and/or the cell seal itself. Due to the required electrical insulation, the cell frame and/or the cell seal are usually made of plastic, but this is often not sufficiently strong and/or rigid enough. In the areas where the cell frame and/or the cell seal run over the passages of the guiding and support clement, deformations can occur in the direction of the passages. The deformations often cause the sealing layer opposite the membrane and the cell frame and/or the cell seal to lose pressure. If the medium is introduced into the port, the medium then exits at the sealing layer. The loss of pressure leads to leakage.

A disadvantage here is the fact that it is difficult to achieve a sufficiently tight connection between the many layers of the individual electrochemical cell. It is therefore desirable to provide an electrochemical cell that prevents or at least reduces pressure loss and/or fluid loss.

The object of the present disclosure is therefore to provide a bipolar plate, an arrangement comprising the bipolar plate, and an electrochemical system comprising a plurality of the stacked bipolar plates or a plurality of the stacked arrangements, which at least partially solves the aforementioned problems.

According to a first aspect of the present disclosure, a bipolar plate for an electrochemical system, for example, an electrolyzer, is proposed. The bipolar plate has a separator plate, the separator plate comprising:
a through-opening as an inlet or outlet for a fluid,
a fluid guiding structure for guiding the fluid, which is arranged at the through-opening and has a plurality of protrusions, at least one passage for guiding the fluid along the separator plate being formed between the plurality of protrusions,
a bead arrangement which partially surrounds the through-opening, and
a flow field with an electrochemically active region, the fluid guiding structure being arranged between the flow field and the through-opening in the direction of flow of the fluid in such a way that the fluid can flow from the through-opening through the fluid guiding structure to the flow field or vice versa,
the bipolar plate further comprising a support element for bridging the fluid guiding structure, wherein the support element is firmly connected to the separator plate.

The support element that is firmly connected to the separator plate for bridging the passages of the fluid guiding structure improves the mechanical support there such that the layers to be applied to the support clement can be reliably sealed against the fluid guiding structure of the separator plate when the stack is under system pressure. This increases safety against leakage. Furthermore, this allows for higher differential pressures and larger cross-sections of the fluid guiding structure.

The thickness of the support element is at most 70%, optionally at most 30% of the thickness of the separator plate.

In addition or alternatively to the predetermined thickness of the support element, the bead arrangement has a first lowered region, wherein a first end of the support element is arranged on the first lowered region. Additionally or alternatively, the bead arrangement has a second lowered region, wherein a second end of the support element is arranged on the second lowered region. The first lowered region and/or the second lowered region of the bead arrangement are adjacent to the fluid guiding structure.

Due to the predetermined small thickness of the support element and the first lowered region and/or the second lowered region of the bead arrangement, on which the first and/or the second end of the support element are arranged, height differences can be prevented or better compensated, so that a sealing effect of the overlying layer can be improved.

The support clement may be particularly rigid and/or solid. The support element can, for example, have a modulus of elasticity of at least 10 GPa in a direction perpendicular to a separator plate plane. This allows the support element to transmit the force to the layers to be applied to the support element without deforming or sagging. The support element can have a higher strength than the plastics used to seal the electrochemical system. This allows a low cell height to be realized. This means that less plastic is needed to achieve the same sealing effect. A thinner plastic layer can also lead to better setting behavior, for example through heat and pressure.

The separator plate is usually designed as a single layer, for example, as a single sheet layer.

That fluid guiding structure for guiding the fluid is arranged at the through-opening does not need to mean that the protrusions immediately start at the edge of the through-opening. Rather, the protrusions have a slight distance to the edge of the through-opening.

The protrusions of the fluid guiding structure can be parallel to each other and may have the same length. Alternatively, the protrusions of the fluid guiding structure can have an angle that opens outwards—i.e. in the direction of the flow field—whereby the fluid can be distributed or collected from the through-opening through the fluid guiding structure to the flow field.

A single passage can be formed between each of two adjacent protrusions of the fluid guiding structure. The passage is used to optimize the flow of the fluid.

In one embodiment, the support element can rest on the protrusions of the fluid guiding structure. The support element thus rests on the protrusions of the fluid guiding structure and can serve particularly well as a support for overlying layers in the region of the fluid guiding structure.

The support element can be designed in the form of a cover plate and cover the fluid guiding structure at least partially, optionally completely. The cover plate can essentially be designed as a flat plate. This allows the support element to transmit the sealing force partially introduced by the protrusions of the fluid guiding structure to a planar force along the cover plate. This distribution of the pressing force can improve tightness and effectively prevent leakage.

In a further embodiment, the support element can be connected to the separator plate in a form-fit, force-fit and/or materially-bonded manner, optionally welded. In the case of a materially-bonded connection, it is possible that the support element and the separator plate are welded together at at least one point on the support element. Optionally, a spot weld can be arranged at one end of the support element, while another spot weld can be arranged at another end of the support element. For example, a material bond can be created using spot welding, friction welding, roller welding, ultrasonic welding, electrode welding, resistance welding or laser welding. In addition, the connection can be made by clamping, embossing, overmolding, flanging or gluing, for example.

In some embodiments, a maximum height of the protrusions of the fluid guiding structure may be less than a maximum height of the bead arrangement. The height is measured perpendicular to a separator plate plane.

Furthermore, the maximum height of the bead arrangement can be greater than a maximum height of the first lowered region and/or a maximum height of the second lowered region of the bead arrangement. Furthermore, the maximum height of the first lowered region and/or the maximum height of the second lowered region of the bead arrangement can be the same as the maximum height of the protrusions of the fluid guiding structure. Each respective height is also measured perpendicular to the separator plate plane. In addition, the support element can have a thickness that is equal to a height difference between the maximum height of the bead arrangement and the maximum height of the first lowered region and/or the maximum height of the second lowered region of the bead arrangement. This compensates for the height difference. Optionally, the bead arrangement and the support element can close the through-opening flush, which can improve the tightness of the system.

It may also be provided that the support element is firmly connected to the separator plate in the first lowered region and/or in the second lowered region of the bead arrangement. On the one hand, space can be created here for the connection, especially in comparison to the neighboring fluid guiding structure. On the other hand, the fluid guidance is not affected by the connection between the support element and the separator plate, which might happen with a connection in the region of the fluid guidance structure.

In addition or alternatively, the support element can be or become subjected to tension at two ends of the support element due to the fixed connection with the separator plate when loaded perpendicular to the separator plate plane, for example, in a compressed state of the electrochemical system or the electrolyzer.

In one embodiment, the fluid guiding structure and/or the bead arrangement can be molded into the separator plate, for example by embossing such as linear embossing, roll embossing, hydroforming and/or deep drawing of the separator plate. In other words, the fluid guiding structure and/or the bead arrangement are an integral part of the separator plate. A bead roof of the bead arrangement and the protrusions of the fluid guiding structure can be directed in the same direction.

The fluid guiding structure can be connected to the through-opening and the through-opening can be enclosed by the fluid guiding structure and the bead arrangement. Furthermore, the flow field can be at a distance from the fluid guiding structure or directly adjacent to the fluid guiding structure.

In a further embodiment, the bipolar plate can comprise a first sealing element for sealing the through opening. The first sealing element can be designed as an elastomer seal, elastomer bead or coating. The first sealing element can, for example, be arranged partially opposite the support element on a side of the separator plate facing away from the support element. Optionally, the first sealing element runs completely around the through-opening. Furthermore, the bead arrangement can form a receptacle for the first sealing element on the side of the separator plate that faces away from the support element. On the side of the separator plate that faces away from the support element, the bead arrangement can form a channel-shaped receptacle to at least partially accommodate the first sealing element. For this purpose, the dimensions of the receptacle of the bead arrangement can essentially correspond to the dimensions of the first sealing element.

In addition to the first sealing element, the bipolar plate can comprise a second sealing element. The second sealing element can also be designed as an elastomer seal, elastomer bead or coating. Typically, the second sealing element is designed to seal at least some regions of the flow field and/or the fluid guiding structure and/or the through-opening. Optionally, the second sealing element runs partially parallel to and along the bead arrangement on a side of the separator plate that faces the support element. The second sealing element is also optionally at a greater distance from the through-opening than the bead arrangement.

In some embodiments, the separator plate may have a recess. The first sealing element can engage in the recess so that the first sealing element is connected to the support clement and the separator plate. The recess means in particular that the separator plate has an opening or interruption. Optionally, the recess in the separator plate is arranged at one of the two ends of the support element in order to facilitate the connection of the first sealing element to the support element. Furthermore, the first sealing element can at least partially fill, or can completely fill the recess in the separator plate.

The support element and the separator plate can be made of different materials. The support element and the separator plate often differ from one another in terms of at least one material property. The support element and the separator plate can also be made of the same materials.

Additionally or alternatively, the support clement can be formed separately from the separator plate and be made from a different material blank than the separator plate. The independent manufacturing option increases the design freedom of both components.

In some embodiments, the support element can be made of metal, e.g. titanium or stainless steel. Since metals have significantly higher strengths than the plastics used for sealing electrolyzers, higher pressures can be applied to the sealing elements. The separator plate can be made at least predominantly of, or entirely of metal, e.g. titanium or stainless steel. Other materials such as alloys are also possible, and the present disclosure is not limited to a specific separator plate material.

According to a second aspect of the present disclosure, an arrangement for an electrochemical system is proposed. The arrangement comprises a bipolar plate of the type described above, a first plastic cell frame and/or a membrane electrode assembly and/or a second plastic cell frame. The support clement according to the present disclosure is arranged between the first plastic cell frame and the separator plate and/or between the membrane electrode assembly and the separator plate and/or between the second plastic cell frame and the separator plate.

The individual elements of the arrangement may be layered in the following order: the bipolar plate, the first plastic cell frame, the membrane electrode assembly and the second plastic cell frame.

In one embodiment, the support element can be designed to support the first plastic cell frame and/or the membrane electrode assembly and/or the second plastic cell frame, for example, in the region of the fluid guiding structure.

According to a third aspect of the present disclosure, an electrochemical system is proposed. The electrochemical system comprises a plurality of stacked bipolar plates of the type described above and/or a plurality of stacked arrangements of the type described above.

The electrochemical system may be, for example, an electrolyzer. However, the present disclosure is not limited to an electrolyzer. Alternatively, the electrochemical system can also be a fuel cell system.

In one embodiment, in which the electrochemical system is an electrolyzer, water is the reaction medium, while hydrogen and oxygen are the product media. In a fuel cell system, hydrogen and oxygen are often the reaction media, while water is the product medium.

Examples of embodiments of the bipolar plate, the arrangement and the electrochemical system are shown in the attached figures and are explained in more detail in the following description.

### BRIEF DESCRIPTION OF THE FIGURES

FIG. 1 shows a perspective view of a part of a bipolar plate according to the prior art.

FIG. 2 shows a perspective view of an electrochemical arrangement with the bipolar plate shown in FIG. 1 and a cell frame.

FIG. 3 shows a sectional view of an electrochemical system with the bipolar plate according to FIG. 1 in an uncompressed state of the electrochemical system.

FIG. 4 shows a sectional view of the electrochemical system according to FIG. 3 in a compressed state of the electrochemical system.

FIG. 5 shows a perspective view of a bipolar plate according to one embodiment.

FIG. 6 shows a perspective view of the bipolar plate according to FIG. 5 with a support element.

FIG. 7 shows a perspective view of an electrochemical arrangement with the bipolar plate according to FIG. 6 and a cell frame.

FIG. 8 shows a sectional view of an electrochemical cell according to one embodiment.

FIGS. 9-14 each show a sectional view of an electrochemical cell according to a further embodiment.

### DETAILED DESCRIPTION

Here and below, features that recur in different figures are denoted in each case by the same or similar reference signs.

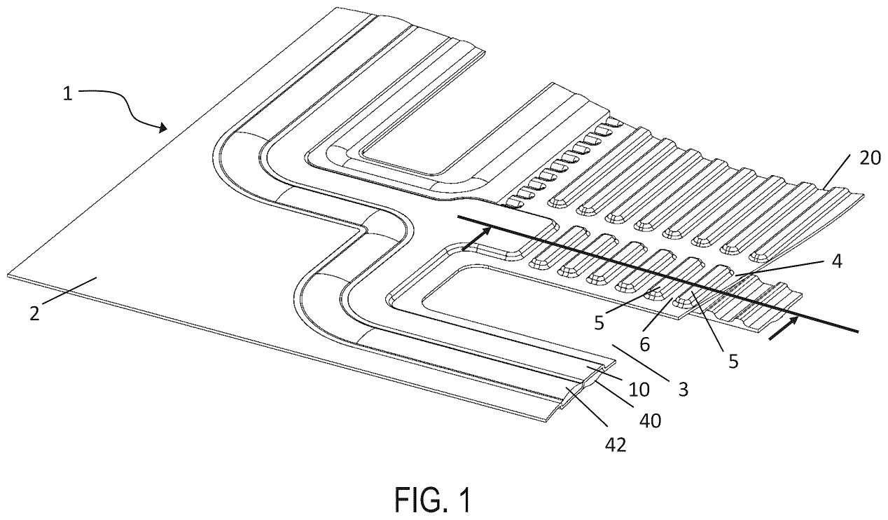

FIG. 1 shows a perspective view of a part of a bipolar plate 1 according to the prior art, which can be part of an electrochemical system. FIGS. 1-14 refer in particular to an application of the bipolar plate 1 in an electrolyzer. Electrolyzers produce, for example, hydrogen and oxygen from water by applying a potential and may at the same time compress at least one of the gases produced. However, the present disclosure is not limited to use in electrolyzers. Rather, the electrochemical system can be a fuel cell system, an electrochemical compressor, a redox flow battery or an electrolyzer. The bipolar plate 1 comprises a separator plate 2. The separator plate 2 is generally designed as a single layer, optionally as a single sheet metal layer, and comprises a through-opening 3 as an inlet or outlet for a fluid and a fluid guiding structure 4 for guiding the fluid. The fluid guiding structure 4 is arranged at the through-opening 3, here not immediately adjacent but somewhat distanced to the through-opening, and has several protrusions 5. In the example shown, a single passage 6 is formed between two adjacent protrusions 5 of the fluid guiding structure 4. The fluid guiding structure 4 is used to guide the flow of fluid. In the case of an electrolyzer, the fluid can, in particular, be water, hydrogen and/or oxygen.

In addition, the separator plate 2 comprises a bead arrangement 10 which partially surrounds the through-opening 3, whereby the bead arrangement 10 can also at least partially surround further through-openings, as indicated in FIG. 1. The separator plate 2 also comprises a flow field 20 with an electrochemically active region. The fluid guiding structure 4 is arranged between the flow field 20 and the through-opening 3. The direction of flow of the fluid can be such that the fluid can flow from the through-opening 3 through the fluid guiding structure 4 to the flow field 20 or vice versa.

In the example shown, the protrusions 5 of the fluid guiding structure 4 are parallel to each other and are of the same length. The flow field 20 adjoins the fluid guiding structure 4, whereby an unembossed, thus planar, region of the separator plate 2 often extends between the flow field 20 and the fluid guiding structure 4. This planar region generally has a length measured in the direction of flow of the fluid that is significantly shorter than the length of the passage 6 or the protrusions 5 measured in the direction of flow of the fluid.

The flow field 20 has channel structures for guiding a reaction or product medium along the separator plate 2. The channel structures of the flow field 20 are usually, but not necessarily, designed as parallel protrusions whose length in the direction of flow of the fluid is often longer than the length of the protrusions 5 of the fluid guiding structure 4.

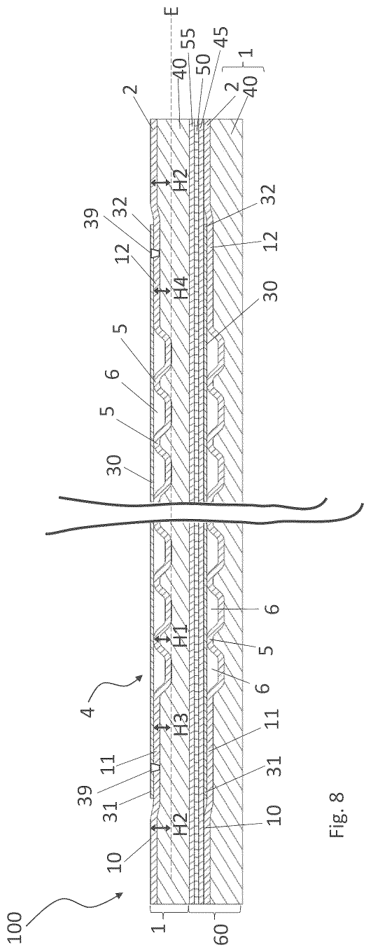

A bead roof of the bead arrangement 10, the protrusions 5 of the fluid guiding structure 4 and the channel structures of the flow field 20 can point in the same direction, optionally perpendicular to a separator plate plane E, and formed into the separator plate 2, for example by embossing such as by linear embossing, roll embossing, hydroforming and/or deep drawing of the separator plate 2. In this document, the term “embossed” is intended to cover all these production methods, unless otherwise stated. The bead roof of the bead arrangement 10, the protrusions 5 of the fluid guiding structure 4 and the channel structures of the flow field 20 are integrated components of the separator plate 2 formed by embossing. The separator plate plane E (sec FIG. 8) is an extended flat surface without embossing.

The fluid guiding structure 4 adjoins an edge that surrounds the through-opening 3. The through-opening 3 can often be completely enclosed by the fluid guiding structure 4 and the bead arrangement 10.

As an alternative to the shape of the protrusions 5 of the fluid guiding structure 4 shown in FIG. 1, the protrusions 5 of the fluid guide structure 4 can have an angle that opens i.e. fan-shaped outwards—i.e. in the direction of the flow field 20—allowing the fluid to be distributed or collected from the through-opening 3 through the fluid guiding structure 4 to the flow field 20.

On a side of the separator plate 2 opposite the fluid guiding structure 4, the bipolar plate 1 as shown in FIG. 1 comprises a first sealing element 40 for sealing the through opening 3. The first sealing element 40 can be designed as an elastomer seal, elastomer bead or coating. Optionally, the first sealing element 40 can run completely around the through-opening 3. The bead arrangement 10 forms a receptacle for the first sealing element 40 on the side of the separator plate 2 facing away from the fluid guiding structure 4. Optionally, the receptacle can be designed as a channel-shaped receptacle in order to at least partially accommodate the first sealing element 40. In this case, the dimensions of the receptacle of the bead arrangement 10 can essentially correspond to the dimensions of the first sealing element 40.

In addition to the first sealing element 40, the bipolar plate 1 usually comprises a second sealing element 42, which is arranged on a side of the separator plate 2 facing away from the first sealing element 40. The second sealing element 42 can also be configured as an elastomer seal, elastomer bead or coating. Typically, the second sealing element 42 is designed to seal at least some regions of the flow field 20 and/or the through-opening 3. In the example shown, the second sealing element 42 runs parallel to and along the bead arrangement 10 and has a greater distance to the through opening 3 than the bead arrangement 10. The second sealing element 42 may rest against a bead wall of the bead arrangement 10.

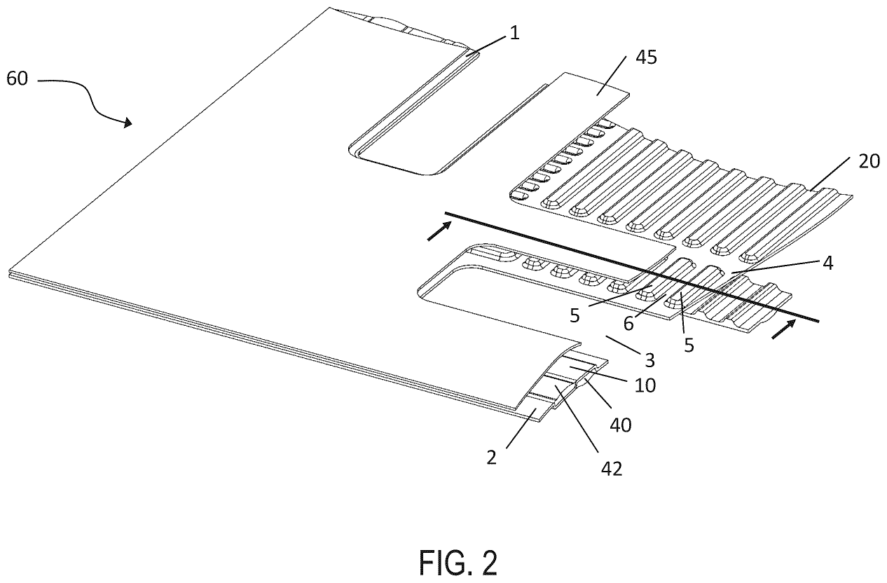

FIG. 2 shows a perspective view of an electrochemical arrangement 60 with the bipolar plate 1 according to FIG. 1 and a cell frame 45, wherein the cell frame 45 rests, inter alia, on the protrusions 5 of the fluid guiding structure 4, the bead arrangement 10 and the sealing element 42.

Thus, the bead roof of the bead arrangement 10 forms a contact surface for the cell frame 45. To improve its sealing function, the bead arrangement 10 can also have a coating on its bead roof. The cell frame 45 serves on the one hand to seal the bipolar plate 1 and on the other hand for electrical insulation. For this reason, the cell frame 45 is usually made of an electrically insulating plastic and can therefore be referred to as a plastic cell frame. In the example shown, the cell frame 45 crosses the passages 6 of the fluid guiding structure 4.

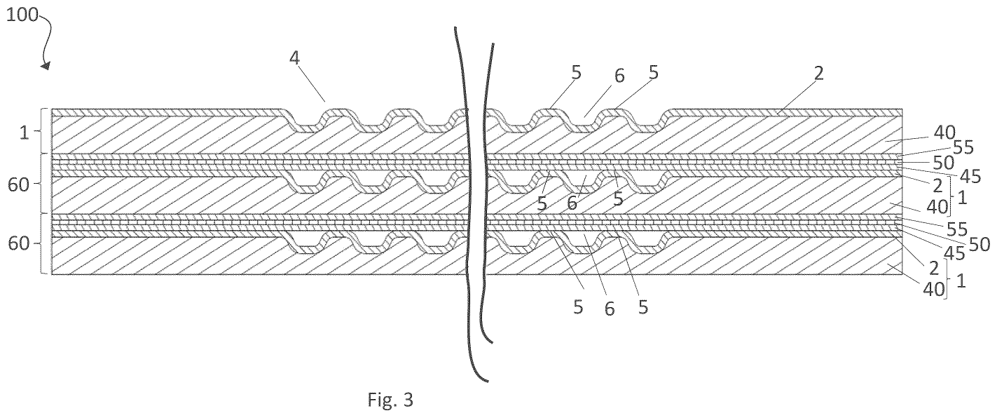

FIG. 3 shows a sectional view of an electrochemical system 100 with the bipolar plate 1 according to FIG. 1 and two stacked arrangements 60 in an uncompressed state of the electrochemical system 100, the two arrangements 60 of FIG. 3 usually each having the same components.

The arrangement 60 according to FIG. 3 differs from the arrangement 60 according to FIG. 2 only in that it additionally comprises a membrane electrode assembly 50 and a second cell frame 55. The position of the cross-section given in FIG. 3 corresponds to the section indicated with arrows in FIG. 2.

Like the first cell frame 45 shown in FIG. 2, the second cell frame 55 can be used for sealing and electrical insulation and is therefore often made of the same material as the first cell frame 45. The two cell frames 45 and 55 can run along the outer edge of the bipolar plate 1. The first cell frame 45 and/or the second cell frame 55 can have recesses in the region of the through-opening 3 and the flow field 20 so that the fluids or media can flow through these recesses.

The actual electrochemical reaction takes place in the electrochemically active region of the flow field 20 at the membrane electrode assembly (MEA) 50. In the region of the flow field 20, a porous transport layer (PTL) and/or a gas diffusion layer (GDL) can be arranged between the membrane electrode assembly (MEA) 50 and the flow field 20, which favors the transport of the fluids/media towards the membrane electrode assembly (MEA) 50 or away from the membrane electrode assembly (MEA) 50. The membrane electrode assembly (MEA) 50 often has a flexible design and is clamped between the two cell frames 45 and 55.

In the example shown, the membrane electrode assembly 50 rests directly on the first cell frame 45, while the second cell frame 55 rests directly on the membrane electrode assembly 50. However, the second cell frame 55 on the opposite side of the MEA 50 can also face the sealing element 40.

The bipolar plate 1 and the arrangements 60 according to FIG. 3 form a stack of individual electrochemical cells of the electrochemical system 100, wherein the arrangement 60 forms the repeating unit of the stack and can be defined by the sequence of the elements 40, 2, 45, 50, 55. An individual electrochemical cell is limited by two neighboring bipolar plates 1.

The electrochemical system 100 shown in FIG. 3 is in an uncompressed state. Before the electrochemical system 100 can be put into operation, the individual layers 2, 45, 50, 55 are pressed together as tightly as possible.

In an electrolyzer, a pressure difference between the surrounding environment and the interior of an electrochemical cell may be more than 20 bar. For example, the pressure on the product side, for example the H₂ side, may be up to 40 bar, while the pressure on the reactant side, for example the H₂O side, is only up to 2 bar. It is therefore important to seal off the flow field 20 from the environment and also within the electrochemical system 100. However, such an electrochemical system 100 as shown in FIG. 3 often has sealing problems.

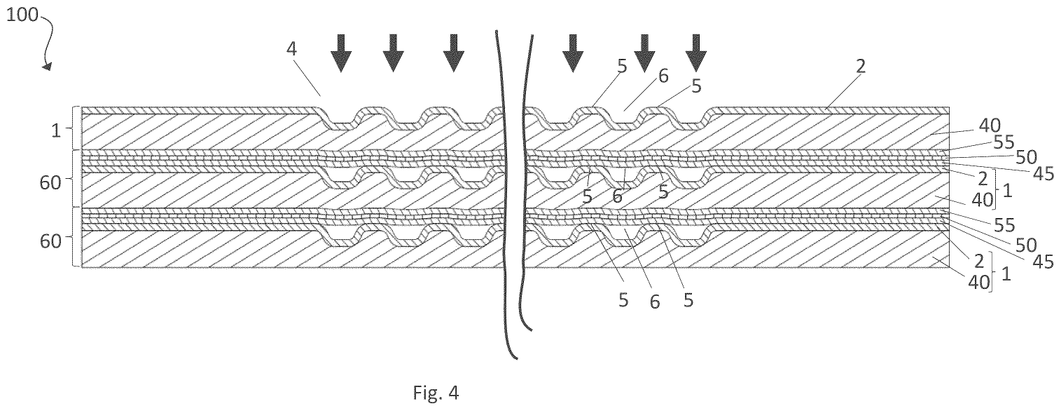

FIG. 4 shows a sectional view of the electrochemical system 100 according to FIG. 3, whereby the electrochemical system in FIG. 4 has been compressed along the stacking direction, i.e. perpendicular to the individual layers 2, 45, 50, 55. The direction of compressing is shown by arrows in FIG. 4.

It can be seen that the layers 45, 50 and 55 are not evenly pressed or deformed in the region of the fluid guiding structure 4, which can lead to sealing problems. This is because the first cell frame 45, the membrane electrode assembly 50 and the second cell frame 55 cross the passages 6 of the fluid guiding structure 4 and are not supported by the bipolar plate 1 in this region. Due to the lack of strength and/or rigidity, the first cell frame 45 cannot transmit sufficient pressure or compression to the membrane electrode assembly 50 and the second cell frame 55 in this region. On the other hand, the region of the fluid guiding structure 4 must be crossed in the case of a single-layer bipolar plate 1, as the anode side and the cathode side of the bipolar plate 1 are made from one sheet, i.e. they lie congruently on top of each other during “stacking” or assembly. At the points at which the first cell frame 45, the membrane electrode assembly 50 and the second cell frame 55 bridge over the passages 6 of the fluid guiding structures 4, deformations can therefore occur in the direction of the passages 6 of the fluid guiding structure 4. The deformations cause the first sealing element 40 to lose pressure. If the medium is introduced into the through-opening 3 (see FIGS. 1 and 2), the medium may then exit at the first cell frame 45. The loss of pressure can lead to leakage, which can disrupt the operation of the electrochemical system 100 or even cause the electrochemical system to fail. Even if the tightness is not impaired by local sagging of the layers, the flow cross-sections of the passages 6 are reduced, which can have a negative effect on the flow behavior of the fluid.

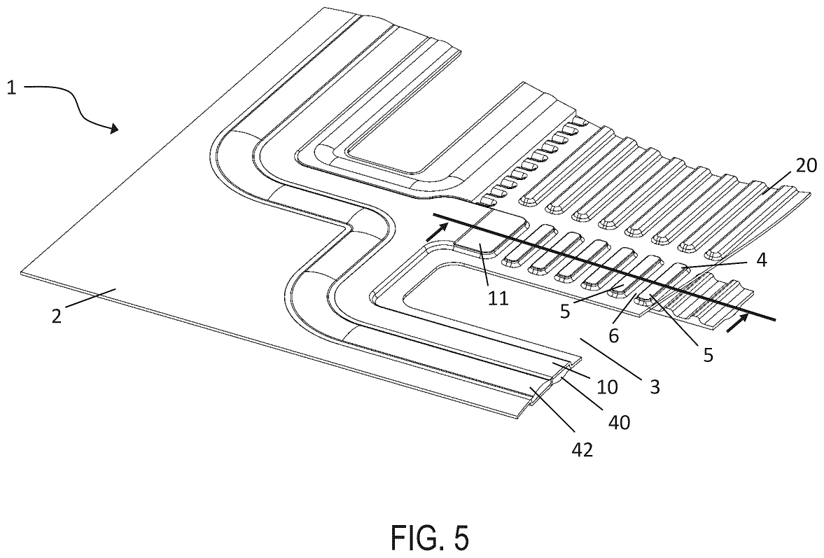

The present disclosure was therefore designed to at least partially reduce or eliminate the disadvantages of the prior art. Embodiments of the present disclosure are shown in FIGS. 5 to 14.

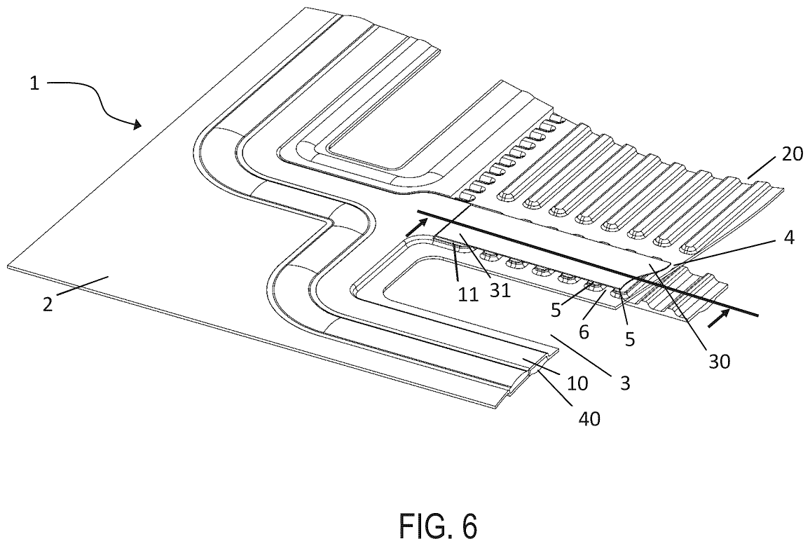

FIGS. 5 and 6 show a perspective view of a separator plate 2 of the bipolar plate 1 according to one embodiment, which prevents or at least reduces the said pressure loss or fluid loss.

FIG. 6 shows the same separator plate 2 of FIG. 5, with an additional support element 30.

The pressing force can be transmitted, through the support element 30 to the layers 45, 50, 55 to be stacked to the support element 30 without the layers 45, 50, 55 deforming or sagging in the region of the passages 6 of the fluid guiding structure 4. Therefore, a stronger mechanical support for the layers 45, 50, 55 is achieved in the region of the fluid guiding structure 4.

The support element 30 is arranged on the fluid guiding structure 4 as a counterpart and abutment to the opposing layers 45, 50, 55. In the embodiment shown, the support element 30 rests on the protrusions 5 of the fluid guiding structure 4 and is supported on the protrusions 5 of the fluid guiding structure 4 that all have equal height. Furthermore, the support element 30 is generally plate-shaped and flat, so that the fluid guiding structure 4 is completely covered by the support clement 30. The through-opening 3 is completely enclosed by the support element 30 and the bead arrangement 10.

In order to keep the bipolar plate 1 as thin as possible, a thickness of the support clement 30 is at most 70%, optionally at most 30% of a thickness of the separator plate 2. This allows for a smaller cell height. For this purpose, the support element 30 may be designed as a separate component from the separator plate 2.

Optionally, the support element 30 consists of a rigid metal sheet layer, e.g. of titanium or stainless steel or metal alloys. Metals are normally stiffer and/or stronger than the plastics of layers 45, 50, 55 used for sealing electrolyzers. For example, the support element 30 can have a modulus of elasticity of at least 10 GPa in a direction perpendicular to the separator plate plane E. The separator plate 2 or its plate body can be formed at least predominantly or completely from the same material as, or from a different material than the support element 30.

The support element 30 is firmly connected to the separator plate 2. This connection can be form-fit, force-fit and/or materially-bonded. A materially-bonded connection means in particular that the support element 30 and the separator plate 2 are welded together at at least one point on the support clement 30, e.g. by means of spot welding, friction welding, roll welding, ultrasonic welding, electrode welding, resistance welding or laser welding. In addition, the connection can be achieved by clamping, embossing, overmolding, flanging or gluing. Exemplary connection types of the support element 30 with the separator plate 2 are shown and discussed later in FIGS. 8 to 14.

The bipolar plate 1 according to FIG. 5 differs further from the bipolar plate 1 according to FIG. 1 in that the bead arrangement 10 according to FIG. 5 has a lowered region 11 and the lowered region 11 of the bead arrangement 10 is adjacent to the fluid guiding structure 4.

The lowered region 11 of the bead arrangement 10 means in particular that a maximum height of the lowered region 11 of the bead arrangement 10 is smaller than a maximum height of the bead arrangement 10 outside the lowered region 11. At the same time, the lowered region is higher than the separator plate 2 in the region of the passages 6 of the fluid guiding structure 4. Here, the lowered region 11 has the same height as the protrusions 5.

It should be noted that although all FIGS. 5 to 14 show the lowered region 11, the bead arrangement 10 need not have a lowered region 11 as long as a thickness of the support element 30 is at most 70%, optionally at most 30% of a thickness of the separator plate 2. Although all FIGS. 5-14 show a lower thickness of the support element 30 compared to the separator plate 2, it is not necessary for the support element 30 to have the required lower thickness than the separator plate 2, as long as the lowered region 11 can compensate for the thickness of the support element 30.

In the embodiment shown in FIG. 6, a first end 31 of the support element 30 is arranged on the lowered region 11 (see FIG. 5) of the bead arrangement 10. The support element 30 often has a thickness that corresponds to the difference between the height differences of the bead arrangement 10 and the protrusions 5 of the fluid guiding structure 4. In other words, the thickness of the support element 30 is height H2−height H1 (see FIG. 8). This prevents or better compensates for height differences.

In some embodiments, a maximum height H1 of the protrusions 5 of the fluid guiding structure 4 can be less than a maximum height H2 of the bead arrangement 10 (see FIG. 8). Additionally or alternatively, the maximum height H2 of the bead arrangement 10 can be greater than the maximum height of the lowered region 11 H3 of the bead arrangement 10 (see FIG. 8). Furthermore, the maximum height H3 of the lowered region 11 of the bead arrangement 10 can be essentially the same as the maximum height H1 of the protrusions 5 of the fluid guiding structure 4 (see FIG. 8). The respective heights are measured perpendicular to the separator plate plane E.

In addition to the lowered region 11 shown, the bead arrangement 10 can comprise a second lowered region 12, which can have the same or similar properties as the first lowered region 11 of the bead arrangement 10. Such a second lowered region 12 of the bead arrangement 10 is shown as an example in FIGS. 8 to 14.

Optionally, the support element 30 is firmly connected to the separator plate 2 in the first lowered region 11 and/or in the second lowered region 12 of the bead arrangement 10. On the one hand, there is sufficient space for the connection, particularly in comparison to the adjacent fluid guiding structure 4. On the other hand, the passages 6 of the fluid guiding structure 4 are not impaired by such a connection.

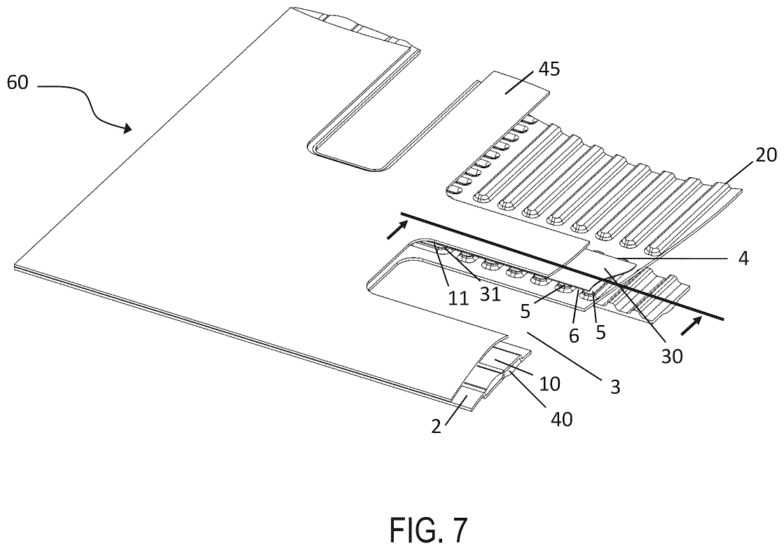

FIG. 7 shows a perspective view of an electrochemical arrangement 60 with the bipolar plate 1 according to FIG. 6 and the cell frame 45.

The cell frame 45 as shown in FIG. 7 can in itself be the same as the cell frame 45 as shown in FIG. 2. The difference is that the cell frame 45 according to FIG. 7 rests on the support element 30, while the cell frame 45 according to FIG. 2 rests directly on the fluid guiding structure 4. Due to the support element 30 for bridging the passages 6 of the fluid guiding structure 4, the cell frame 45 no longer exhibits any deformation in the region of the passages 6 of the fluid guiding structure 4 in the compressed state.

Due to the fixed connection with the separator plate 2, the support element 30 can be or can become subjected to tensile load at two ends of the support element 30 when loaded perpendicular to the separator plate plane E, for example, in a compressed state of the electrochemical system 100 or the electrolyzer.

FIGS. 8 to 14 each show a sectional view of an electrochemical system 100 according to different embodiments, in which a connection between the support element 30 and the separator plate 2 is configured differently. FIGS. 8-14 show only one electrochemical cell of the electrochemical system 100. Of course, the electrochemical system 100 can have a large number of such cells. Each electrochemical cell 100 according to FIGS. 8 to 14 comprises two bipolar plates 1, which are spaced apart by the first cell frame 45, the membrane electrode assembly 50, and the second cell frame 55. An electrochemical arrangement 60 according to FIGS. 8 to 14 comprises the corresponding bipolar plate 1, the first cell frame 45 which is arranged directly on the support clement 30 of the bipolar plate 1, the membrane electrode assembly 50 which is arranged directly on the first cell frame 45, and the second cell frame 55 which is arranged directly on the membrane electrode assembly 50. The support element 30 according to FIGS. 8 to 14 is configured to support the first cell frame 45 and/or the membrane electrode assembly 50 and/or the second cell frame 55.

Similar to FIGS. 5-7, the bead arrangement 10 of the bipolar plate 1 according to FIG. 8 has the first lowered region 11 and a second lowered region 12. The first lowered region 11 and/or the second lowered region 12 of the bead arrangement 10 can be produced in the same embossing step as the channel structures of the flow region 20, the protrusions 5 of the fluid guiding structure 4 and the rest of the bead arrangement 10. A first end 31 of the support element 30 is arranged on the first lowered region 11 of the bead arrangement 10 and a second end 32 of the support element 30 is arranged on the second lowered region 12 of the bead arrangement 10, wherein both the first lowered region 11 and the second lowered region 12 of the bead arrangement 10 are adjacent to the fluid guiding structure 4.

By analogy with FIGS. 5-7, in particular with the first lowered region 11 shown there, in FIG. 8 the maximum height H2 of the bead arrangement 10 is greater than a maximum height H4 of the second lowered region 12 of the bead arrangement 10. Furthermore, the maximum height H4 of the second lowered region 12 of the bead arrangement 10 is essentially the same as the maximum height H1 of the protrusions 5 of the fluid guiding structure 4. The respective heights are measured perpendicular to the separator plate plane E. In addition, the support element 30 can have a thickness that is equal to a height difference between the maximum height H2 of the bead arrangement 10 and the maximum height H4 of the second lowered region 12 of the bead arrangement 10.

The support element 30 can be firmly connected to the separator plate 2 in the second lowered region 12 of the bead arrangement 10. For example, a welding point or a welding line 39 can be arranged at the first end 31 of the support element 30, while a further welding point or a further welding line 39 can be arranged at the second end 32 of the support element 30. Alternatively, the support element 30 with the first lowered region 11 and the second lowered region 12 of the bead arrangement 10 can be firmly connected to the separator plate 2 by means of adhesive.

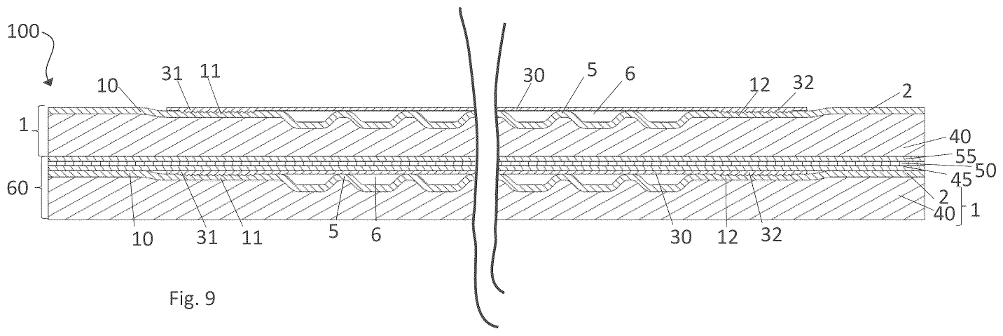

The electrochemical cell 100 according to FIG. 9 is similar to the electrochemical cell 100 according to FIG. 8 and differs from the electrochemical cell 100 according to FIG. 8 in that the support element 30 according to FIG. 9 is connected to the separator plate 2 in a frictionally engaged and/or form-fitting manner.

For this purpose, the first lowered region 11 and the second lowered region 12 of the bead arrangement 10 can each have a textured surface such as a serrated surface, while the first end 31 and the second end 32 of the support element 30 each have a corresponding textured surface such as a serrated surface. The two structured surfaces are often formed in such a way, e.g. shaped to complement each other, that they can interlock to form the connection.

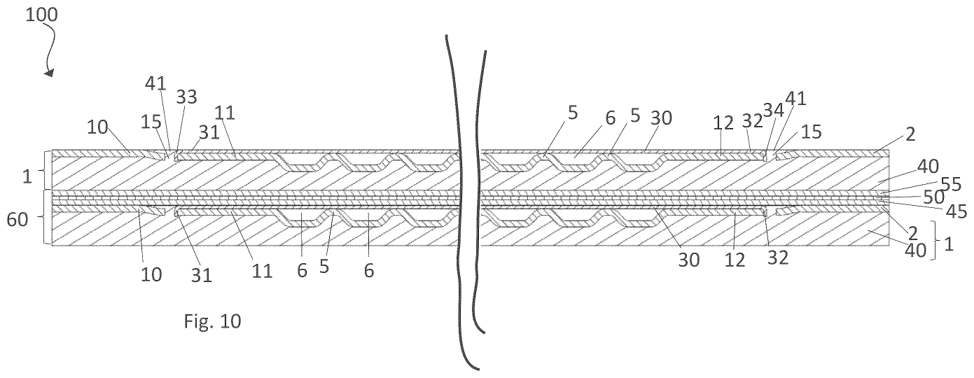

FIG. 10 shows a sectional view of an electrochemical cell 100 according to a further embodiment.

The separator plate 2 as shown in FIG. 10 has two recesses 15. A first of the recesses 15 is arranged in the first lowered region 11 of the bead arrangement 10 and a second of the recesses 15 is arranged in the second lowered region 12 of the bead arrangement 10. The recesses 15 can be created, for example, by punching or cutting the separator plate 2.

The sealing element 40, in particular a projection or protrusion 41 formed integrally with the sealing element 40, engages with the recesses 15 so that the sealing element 40 is connected to the support element 30 and the separator plate 2. In the embodiment shown, the sealing element 40 completely fills the recesses 15 of the separator plate 2.

When manufacturing the bipolar plate 1, the support element 30 and the separator plate 2 can initially be placed on top of each other. An edge 33, 34 of the support element 30 is then bent around the edge of the recess 15.

Alternatively, the edge 33, 34 of the support element 30 can also be angled away from the rest of the support element 30 beforehand, for example angled perpendicular to the separator plate plane E. When mounting the support element 30, the edge 33, 34 is then inserted into the recess 15.

A liquid or paste-like elastomer compound is then injected onto the back of the separator plate 2. The elastomer compound enters the recess 15 and bonds with the support element 30, in particular with its corresponding edges 33, 34. Once the elastomer compound has hardened, the sealing element 40 is formed, which is bonded to the support element 30.

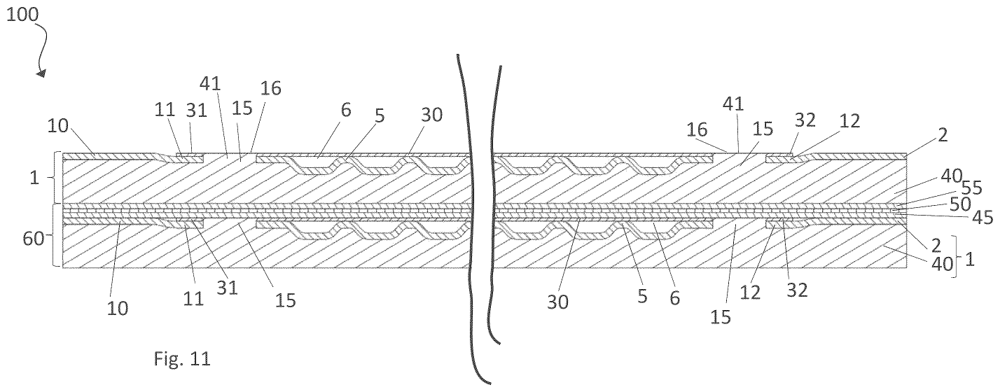

FIG. 11 shows a sectional view of an electrochemical cell 100 according to a further embodiment.

The electrochemical cell 100 shown in FIG. 11 is similar to the electrochemical cell 100 shown in FIG. 10. In FIG. 11, the bead arrangement 10 and the support element 30 each have two recesses 15.

The sealing element 40, or more precisely, a projection or protrusion 41 formed integrally with the sealing element 40, engages with the recesses 15 so that the sealing element 40 is connected to the support element 30 and the separator plate 2. The sealing element 40 completely fills the recesses 15 of the bead arrangement 10 and the support element 30.

When manufacturing the bipolar plate 1, the support element 30 can be applied to the separator plate 2, whereby the recess 15 of the separator plate 2 is brought into alignment with a corresponding recess 16 of the support element 30. A liquid or paste-like elastomer compound is then also injected into the recesses 15 from the rear of the separator plate 2. The elastomer compound completely fills the recesses 15 and is then dried out. Once the elastomer compound has hardened, the sealing element 40 is formed, which is bonded to the support element 30.

Alternatively, the recesses 15, 16 of the separator plate 2 and the support element 30 can be produced after the support element 30 has been applied to the separator plate 2 by simultaneously punching or cutting the separator plate 2 and the support element 30 lying thereon in a punching or cutting step.

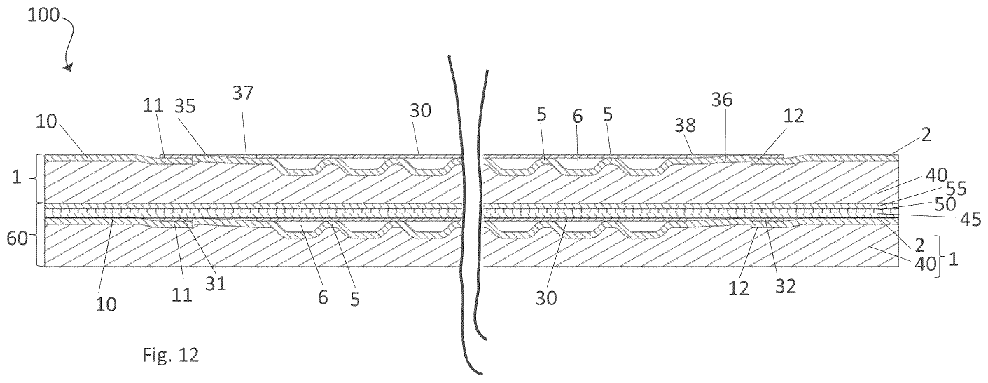

FIG. 12 shows a sectional view of an electrochemical cell 100 according to a further embodiment.

In this embodiment, the separator plate 2 has two embossings 35, 36 in the region of the connection with the support element 30, which protrude from a surface of the first lowered region 11 and a surface of the second lowered region 12 of the bead arrangement 10.

In this embodiment, the support element 30 has two openings 37 and 38, which are arranged adjacent to two ends of the support element 30. The openings 37, 38 can be produced in advance by punching or cutting the support element 30. The embossings 35, 36 are inserted into the openings 37, 38 and each form a form-fit connection, optionally also a force-fit connection.

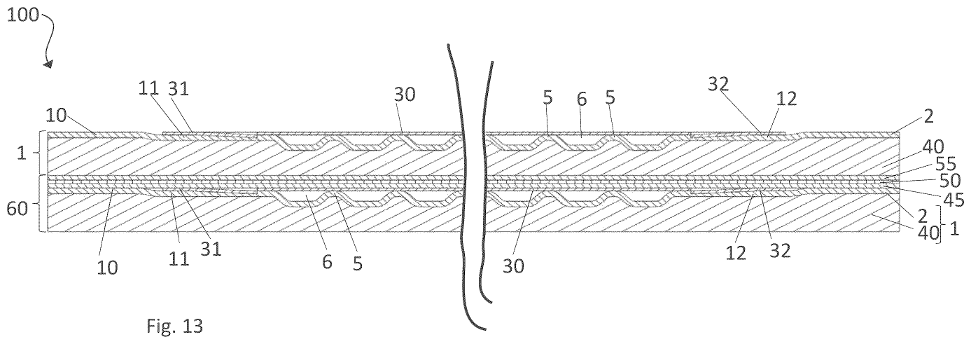

FIG. 13 shows a sectional view of an electrochemical cell 100 according to a further embodiment.

The electrochemical cell 100 shown in FIG. 13 is similar to the electrochemical cell 100 shown in FIG. 12. In this embodiment, the first lowered region 11 of the bead arrangement 10 is divided into two parts. A first part is provided with a variable thickness, whereby the variable thickness gradually decreases towards the fluid guiding structure 4. A second portion is provided with a constant thickness and is adjacent to the fluid guiding structure 4 compared to the first portion, the constant thickness being equal to a thickness of the bead arrangement 10 outside the first lowered region 11 of the bead arrangement 10. The support element 30 can now be mounted in a form-fit manner on the edge that is created at the transition from the first to the second part of the lowered region.

The second lowered region 12 of the bead arrangement 10 is also divided into two parts. A first part of the second lowered region 12 is provided with a variable thickness, this variable thickness gradually decreasing towards the fluid guiding structure 4. A second part of the second lowered region 12 has a constant thickness and is adjacent to the fluid guiding structure 4 compared to the first part of the second lowered region 12, the constant thickness being equal to the thickness of the bead arrangement 10 outside the second lowered region 12 and the first lowered region 11 of the bead arrangement 10.

When manufacturing the bipolar plate 1 according to FIG. 13, the first end 31 and the second end 32 of the support element 30 are pressed in the direction of the passages 6 of the fluid guiding structure 4 into the first part of the first lowered region 11 and into the first part of the second lowered region 12 of the bead arrangement 10, respectively, in such a way as to form a connection between the support element 30 and the separator plate 2, respectively. After pressing, the first end 31 and the second end 32 of the support element 30 rest on the first part of the first lowered region 11 and the first part of the second lowered region 12 of the bead arrangement 10. In addition, where the first parts are adjacent to the second parts, the support element 30 and the separator plate 2 can be welded together.

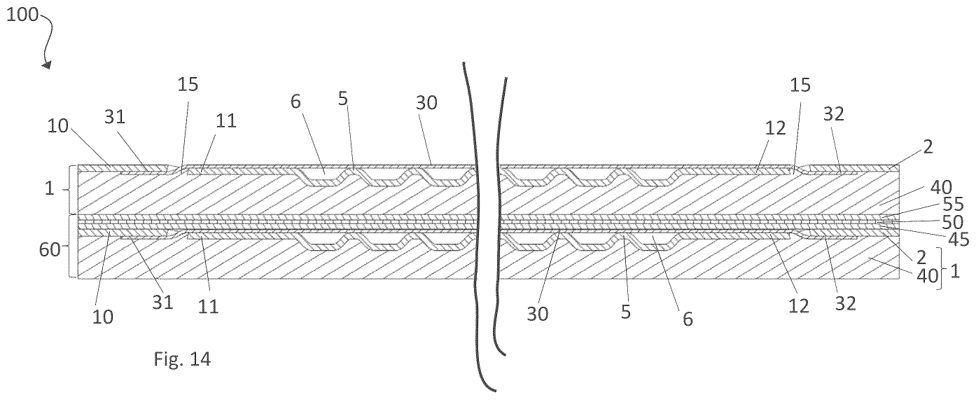

FIG. 14 shows a sectional view of an electrochemical cell 100 according to a further embodiment.

The separator plate 2 as shown in FIG. 14 has two recesses 15, which are produced, for example, by punching or cutting the separator plate 2.

When manufacturing the bipolar plate 1 as shown in FIG. 14, the support element 30 can first be applied to the separator plate 2. The first end 31 of the support element 30 can then be inserted into the first recess 15 along the separator plate 2 in such a way that part of the support element 30 rests below the separator plate 2. Likewise, the second end 32 of the support element 30 can be inserted into the second recess 15 along the separator plate 2 in such a way that a further part of the support element 30 rests below the separator plate 2.

In FIG. 14, the sealing element 40 also engages with the recesses 15 so that the sealing element 40 is connected to the support element 30 and the separator plate 2. However, the sealing element 40 only partially fills the recesses 15 of the separator plate 2 here.

After the cutting of the recesses 15, it is for instance possible that the free ends of the support element 30 are inserted through these recesses, so that the free ends come to lie underneath the bead 10. In a joint forming step, the area of the separator plate 2 adjacent to the fluid guiding structure 4 and the area of the support element 30 resting on this area can be embossed in such a way that the embossed area of the separator plate 2 extends in a plane parallel to the plane E of the separator plate which is lower than the plane of the bead 10 opposite to the respective recesses 15.

Alternatively, the separator plate 2 can be embossed underneath the separator plate 2 before the support element 30 passes through in order to create the first lowered region 11 and the second lowered region 12 of the bead arrangement prior to inserting the free ends of the support element 30.

Individual features of the bipolar plates and arrangements described above and shown in the figures can be claimed individually or in combination with each other, provided that the combination of features does not contradict each other.

### LIST OF REFERENCE SIGNS

1 bipolar plate
2 separator plate
3 through-opening
4 fluid guiding structure
5 protrusions
6 passage
10 bead arrangement
11 first lowered region of the bead arrangement 10
12 second lowered region of the bead arrangement 10
15 recess
16 recess
20 flow field
30 support element
31 first end of the support element 30
32 second end of the support element 30
33, 34 edge of the support element 30
35, 36 embossing of the separator plate
37 first opening of the support element 30
38 second opening of the support element 30
39 spot welds
H1 maximum height of the protrusions 5
H2 maximum height of the bead arrangement 10
H3 maximum height of the first lowered region 11
H4 maximum height of the second lowered region 12
E separator plate plane
40 first sealing element
41 protrusion or projection of the first sealing element 40
42 second sealing element
45 first plastic cell frame
50 membrane electrode assembly
55 second plastic cell frame
60 electrochemical arrangement
100 electrochemical system

1. A bipolar plate for an electrochemical system comprising a separator plate, the separator plate comprising:
a through-opening as inlet or outlet for a fluid,
a fluid guiding structure for guiding the fluid, which is arranged at the through-opening and has a plurality of protrusions, at least one passage for guiding the fluid along the separator plate being formed between the plurality of protrusions,
a bead arrangement which partially surrounds the through-opening, and
a flow field with an electrochemically active region, the fluid guiding structure being arranged between the flow field and the through-opening in a direction of flow of the fluid in such a way that the fluid can flow from the through-opening through the fluid guide structure to the flow field or vice versa,
the bipolar plate further comprising a support element for bridging the fluid guiding structure, wherein the support element is firmly connected to the separator plate,
wherein a thickness of the support element is at most 70% of a thickness of the separator plate.

2. A bipolar plate for an electrochemical system comprising a separator plate, the separator plate comprising:
a through-opening as inlet or outlet for a fluid,
a fluid guiding structure for guiding the fluid, which is arranged at the through-opening and has a plurality of protrusions, at least one passage for guiding the fluid along the separator plate being formed between the plurality of protrusions,
a bead arrangement which partially surrounds the through-opening, and
a flow field with an electrochemically active region, the fluid guiding structure being arranged between the flow field and the through-opening in a direction of flow of the fluid in such a way that the fluid can flow from the through-opening through the fluid guiding structure to the flow field or vice versa,
the bipolar plate further comprising a support element for bridging the fluid guiding structure, wherein the support element is firmly connected to the separator plate,
wherein the bead arrangement has a first lowered region and a first end of the support element is arranged on the first lowered region and/or wherein the bead arrangement has a second lowered region and a second end of the support element is arranged on the second lowered region, wherein the first lowered region and/or the second lowered region are adjacent to the fluid guiding structure.

3. The bipolar plate according to claim 1, wherein the support element rests on the protrusions of the fluid guiding structure.

4. The bipolar plate according to claim 1, wherein the support element is designed in the form of a cover plate and covers the fluid guiding structure at least partially.

5. The bipolar plate according to claim 1, wherein the support element is connected to the separator plate in a form-fitting, force-fitting and/or materially-bonded manner.

6. The bipolar plate according to claim 1, wherein a maximum height (H1) of the protrusions of the fluid guiding structure is less than a maximum height (H2) of the bead arrangement, wherein height (H1, H2) is measured perpendicular to a separator plate plane (E).

7. The bipolar plate according to claim 2, wherein a maximum height (H2) of the bead arrangement is greater than a maximum height (H3) of the first lowered region and/or a maximum height (H4) of the second lowered region, wherein the maximum height (H3) of the first lowered region and/or the maximum height (H4) of the second lowered region (of the bead arrangement is equal to a maximum height (H1) of the protrusions, and wherein the respective height (H1, H2, H3, H4) is measured perpendicular to a separator plate plane (E).

8. The bipolar plate according to claim 2, wherein the support element is firmly connected to the separator plate in the first lowered region and/or in the second lowered region of the bead arrangement.

9. The bipolar plate according to claim 1, wherein the support element is loaded in tension at its two ends by the firm connection with the separator plate when loaded perpendicularly to a separator plate plane (E).

10. The bipolar plate according to claim 1, wherein the fluid guiding structure and/or the bead arrangement are molded into the separator plate.

11. The bipolar plate according to claim 1, wherein the fluid guiding structure adjoins the through-opening and the through-opening is enclosed by the fluid guiding structure and the bead arrangement, and/or wherein the flow field is spaced apart from the fluid guiding structure.

12. The bipolar plate according to claim 1, wherein the bipolar plate comprises a sealing element for sealing the through-opening, wherein the sealing element is formed as an elastomer seal and is arranged partially opposite the support element on a side of the separator plate that faces away from the support element, and wherein the bead arrangement forms a receptacle for the sealing element on the side of the separator plate that faces away from the support element.

13. The bipolar plate according to claim 12, wherein the separator plate has a recess and the sealing element engages in the recess, so that the sealing element is connected to the support element and the separator plate.

14. The bipolar plate according to claim 13, wherein the sealing element at least partially or completely fills the recess of the separator plate.

15. The bipolar plate according to claim 1, wherein the support element and the separator plate are made of different materials, and/or wherein the support element is formed separately from the separator plate.

16. The bipolar plate according to claim 1, wherein the support element has a modulus of elasticity of at least 10 GPa in a direction perpendicular to a separator plate plane (E).

17. The bipolar plate according to claim 1, wherein the support element is made of metal, e.g. titanium or stainless steel, and/or wherein the separator plate is at least predominantly or completely made of metal, e.g. titanium or stainless steel.

18. An arrangement for the electrochemical system comprising the bipolar plate according to claim 1, wherein the arrangement comprises a first plastic cell frame and/or a membrane electrode unit and/or a second plastic cell frame, and wherein the support element is arranged between the first plastic cell frame and the separator plate and/or between the membrane electrode unit and the separator plate and/or between the second plastic cell frame and the separator plate.

19. The arrangement according to claim 18, wherein the support element is configured to support the first plastic cell frame and/or the membrane electrode unit and/or the second plastic cell frame.

20. The electrochemical system comprising a plurality of stacked bipolar plates according to claim 1.
